(19) United States
(12) Patent Application Publication
(10) Pub. No.: US 2008/0306642 A1
(43) Pub. Date: Dec. 11, 2008

(54) Remote controlled position sensing and auto-leveling boat lift controller

(75) Inventors: John A. Figura, Defiance, MO (US); Matthew L. Narzinski, St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: Aqualogic Marine, Inc., Washington, MO (US)

(21) Appl. No.: 12/157,244

(22) Filed: Jun. 7, 2008

Related U.S. Application Data
(60) Provisional application No. 60/942,805, filed on Jun. 8, 2007.

(51) Int. Cl. G06F 17/00; B63C 1/06

(52) U.S. Cl. 701/21; 114/45

(57) ABSTRACT

The present invention disclosure relates to boat lifts and in particular a boat lift preferably employing to a remote controlled, position sensing and auto-leveling boat lift controller. The controller is capable of monitoring the height of the lift relative to the surface of the water and the angle of the lift relative to horizontal level. The controller filters out the effects of wave action or other interfering conditions, obtaining precise measurements of the height and angle. The controller continuously maintains both height and angle at the position set by the operator.

### CROSS-REFERENCE TO RELATED APPLICATIONS

This application claims priority to provisional application Ser. No. 60/942,805 filed Jun. 8, 2007 which is incorporated herein by reference.

### STATEMENT REGARDING FEDERALLY SPONSORED RESEARCH

Not Applicable.

### BACKGROUND OF THE INVENTION

The statements in this section merely provide background information related to the present disclosure and may not constitute prior art.

Boat lifts of various forms are well known. Conventionally, they take several forms including pneumatic and cable lift systems. Boat owners often employ the systems in conjunction with their boat slips and docks. When the lifts operate properly, the boats are raised out of the water without incident. However, historically lifts have had a number of problems. In an air style (pneumatic) lift, air flow restrictions, leaks in the air tanks or lines, or changes in the boat's center of gravity due to loading of fuel, water or gear may cause the lift to assume a listed condition. Air leaks in the tanks of a boat in a raised condition may be severe enough to roll the boat off the lift. Air lifts are also susceptible to burping (large waves lifting one corner of the lift releasing air, causing a list to that side). Similar conditions may cause list in other cable types of lifts. In any event, none of the lifts in the market provide automatic adjustments for both the vertical position and list (front to back and side to side) position of the lift.

The operating controls on typical lifts are fixedly mounted to the lift or dock, usually out of reach from within a boat on the lift. Controls of this type can make it difficult for the operator to both steady the boat and operate the lift simultaneously.

The present disclosure permits continuous measurement and adjustment of the vertical position and list angle on any type lift and has the capability to filter out the effects of wave action and other interfering conditions on those measurements, in addition to or with the remote control of those conditions.

### BRIEF SUMMARY OF THE INVENTION

According to one aspect of the disclosure, a boat lift controller is provided which includes pressure and tilt sensors. The sensors are connected to a microcontroller that can filter the effects of wave action and other interfering conditions allowing precise angle and height measurements. An interface to the control electronics permits the microcontroller to raise or lower one side of the lift to maintain the lift in a level position at the desired height.

Further aspects of the present disclosure will be in part apparent and in part pointed out below. It should be understood that the various aspects of the disclosure may be implemented individually or in combination with one another. It should also be understood that the detailed description and drawings, while indicating certain exemplary embodiments, are intended for purposes of illustration only and should not be construed as limiting the scope of the disclosure.

The foregoing and other objects, features, and advantages of the invention as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a diagrammatic view of one illustrative embodiment of position sensing and auto-leveling boat lift controller system of the present disclosure, illustrating the down position of the lift;

FIG. 2 is a diagrammatic view of the system shown in FIG. 1 illustrating the board position of the lift;

FIG. 3 is a diagrammatic view of the system shown in FIG. 1 illustrating the up position of the lift;

FIG. 4 is a diagrammatic view of the system shown in FIG. 1 illustrating the port tilted position of the lift;

FIG. 5 is a diagrammatic view of the system shown in FIG. 1 illustrating the starboard tilted position of the lift;

FIG. 6 is a diagrammatic view of one illustrative embodiment of control arrangement employed with the system of FIG. 1; and

FIG. 7 is a more detail block diagram of the control arrangement of FIG. 6.

Corresponding reference numerals indicate corresponding parts throughout the several figures of the drawings.

### DESCRIPTION OF THE PREFERRED EMBODIMENT

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention. The Description is primarily exemplary in nature and is not intended to limit the present disclosure or the disclosure's possible applications or uses. While the invention is described in particular detail with respect to pneumatic boat lifts, those skilled in the art will recognize the wider applicability of the inventive principles disclosed herein.

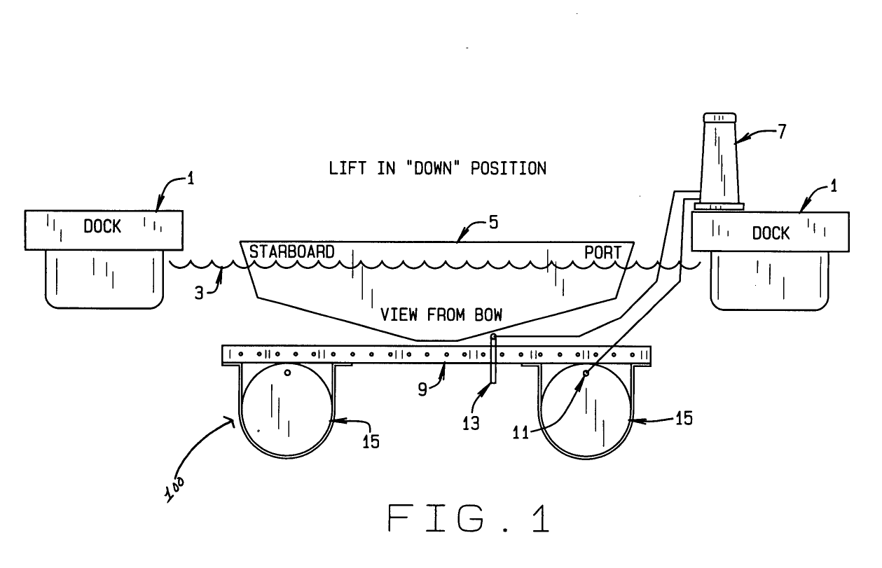

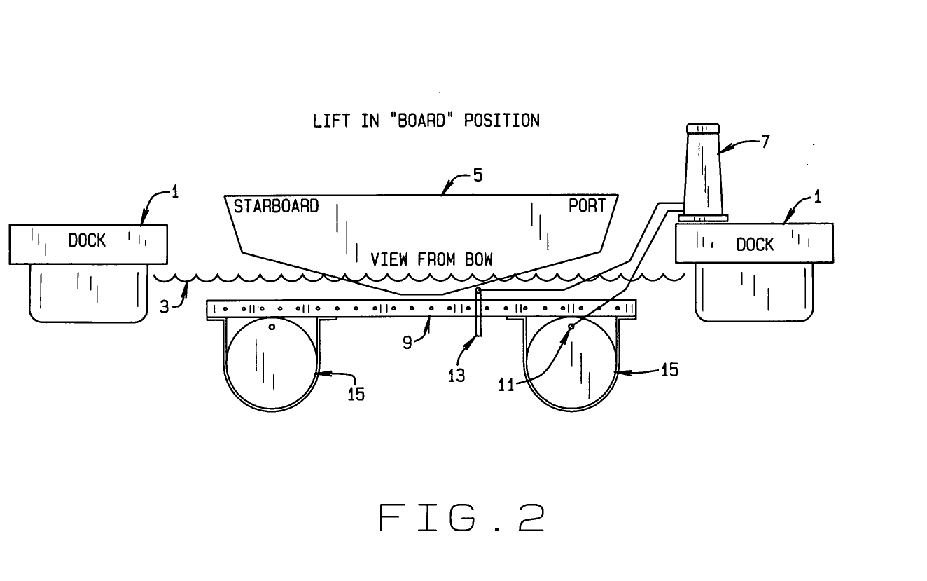

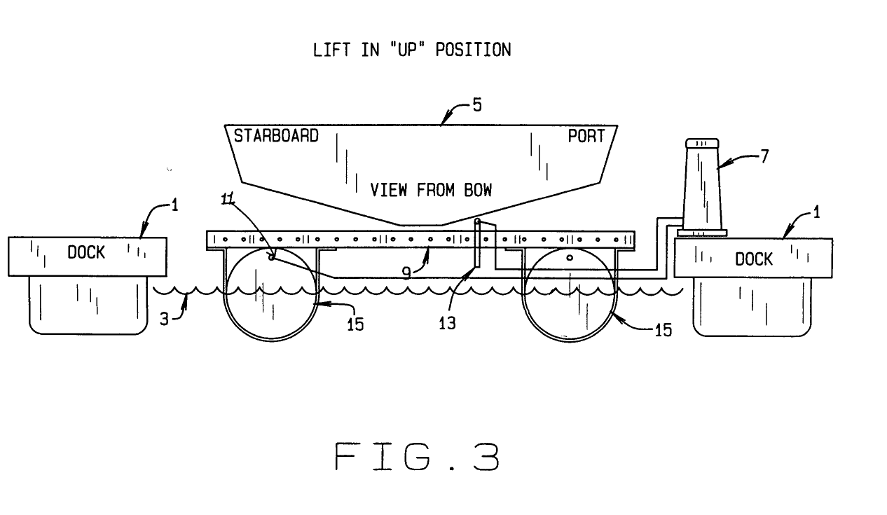

As shown in FIGS. 1-7, a boat lift controller for a boat lift 100 illustratively indicated in diagrammatic fashion. The boat lift per se is not described in detail, as any commercially available lift may be utilized with the present invention. The boat lift controller includes a control box 7. In the embodiment illustrated, the control box 7 contains a microcontroller 23 which is connected to a pressure transducer 11 and an accelerometer device 13. The pressure transducer 11 monitors the gauge pressure of the depth of water and thus the position of the lift 9 relative to the surface of the water 3. The pressure transducer 11 preferably is vented to the atmosphere so barometric pressure changes do not affect the position readings. The microcontroller 23 continuously reads and processes the pressure readings and is adapted to filter out wave action or other unrelated water disturbance that might otherwise affect the accuracy of the position reading.

List detection and correction is accomplished thru the accelerometer device 13 or other suitable tilt sensor attached to the lift 9 at any acceptable location. In the preferred embodiment of the invention, the microcontroller 23 continuously reads and processes the angle of the lift 9 relative to a horizontal level detected from the accelerometer device 13. The control box 7 automatically induces the lift 9 to either raise or lower one side of the lift 9 to maintain the system in a level condition.

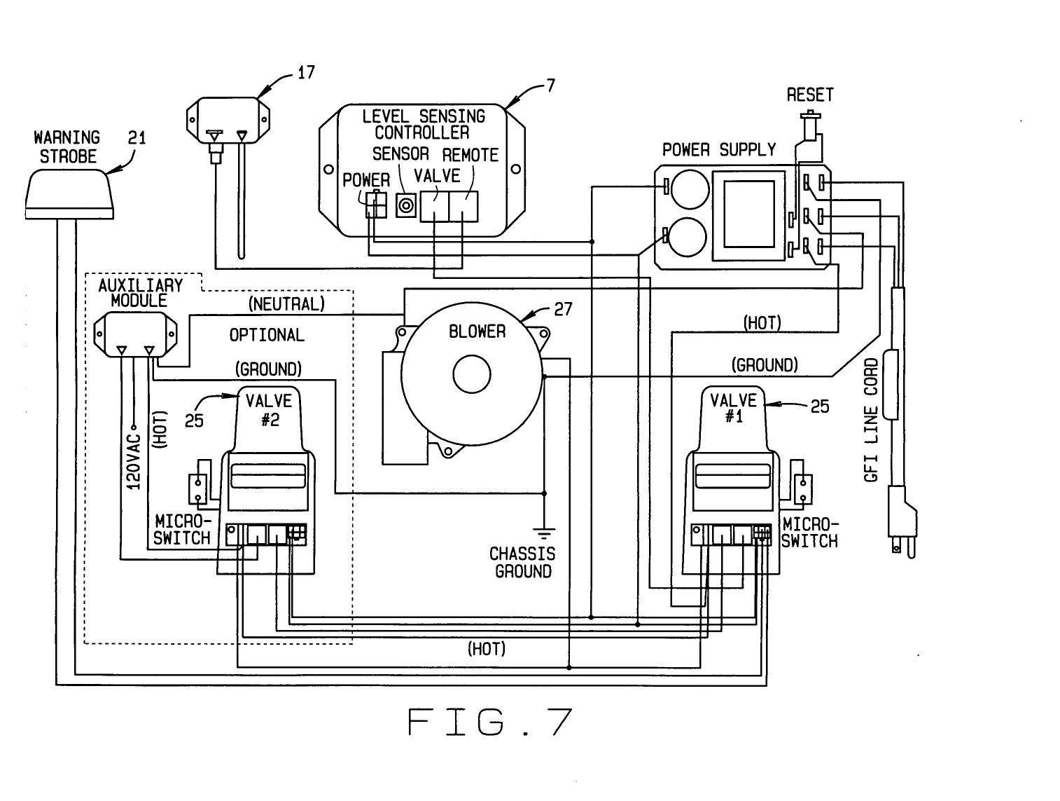

If the microcontroller 23 detects a list in the lift 9, the control box 7 induces a valve 25 to open. The action of the valve 25 may induce a blower 27 to activate, forcing air into the air tank 15. In some instances, the valve 25 may open to release air from the air tank 15 having with the greater amount of pressure. As shown in FIG. 7, multiple valves 25 may be employed depending on the number of air tanks 15 coupled with the lift 9. A warning strobe 21 or other display options providing visual alerts, indicating valve 25 activity or position of the lift 9 may be utilized if the user desires.

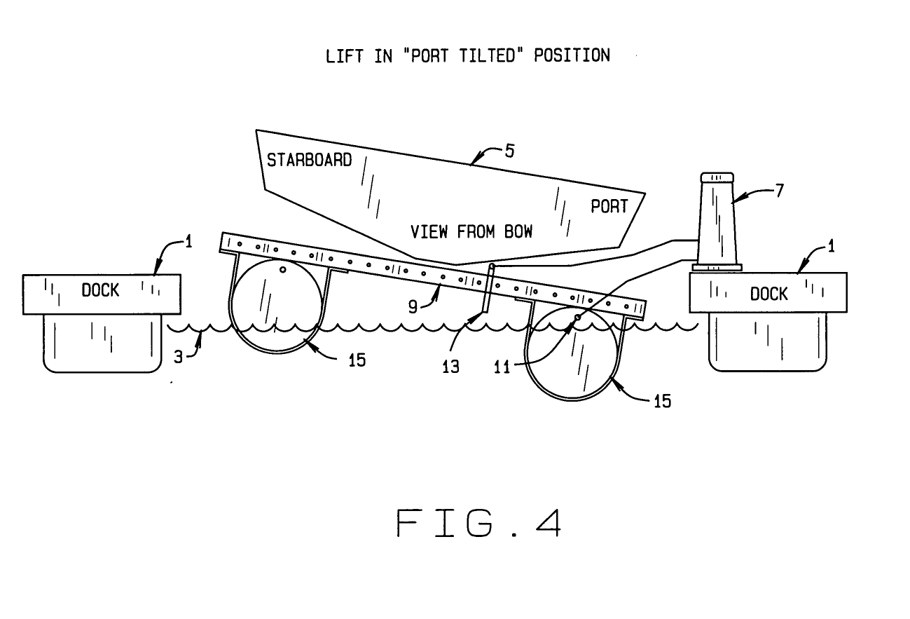

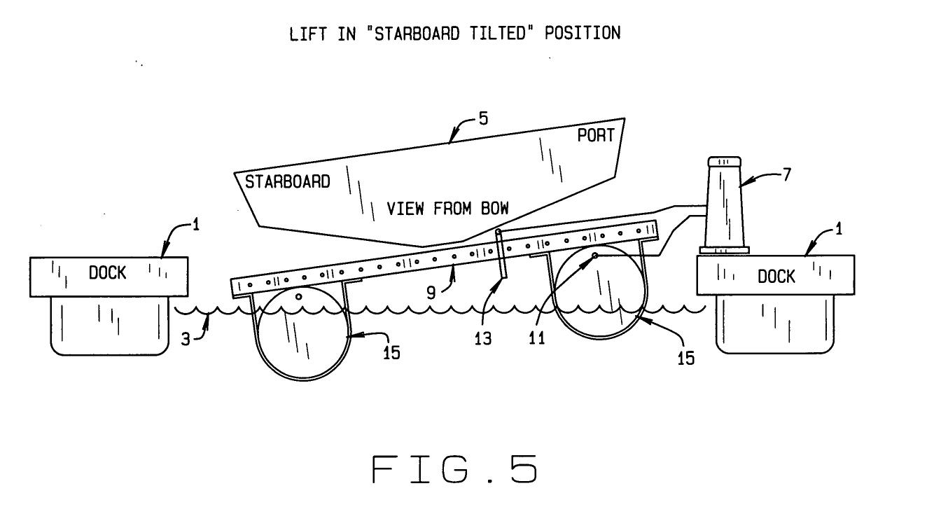

As indicated above, one of the inherent flaws of boat lifts 9 in general is the unequal balancing of the boat 5 being lifted. The center of gravity of the boat 5 changes with the loading of fuel, water, equipment and similar things that affect boat weight, causing the lift 9 to list, as shown in FIGS. 4 and 5. In an air style lift, depending on air flow restrictions, leaks and the like, cause the lift 9 to raise or lower in a listed condition. When the list is caused by a substantial air leak, the boat 5, being lifted, can roll off the lift 9. Similarly, the boat 5 can roll off the lift 9 as the boat is being lifted. The system of the present disclosure monitors the angle of the lift 9 relative to a horizontal level.

One feature of the present disclosure is the ability to monitor the lift position continuously, so that even if the boat lift 9 were to lower itself due to an air leak, for example, the system will detect the change and automatically activate corrective action to maintain the position set by the user. Predetermined positions set by the user may be inputted in the control box 7 through a keypad 19 or other user interface device.

Another feature of the present disclosure is that improper installation in pneumatic systems will not affect the boat lift controller. For example, if someone moves the lift 9 and connects the hoses up backwards from the previous installation, the controller senses the condition and adjusts for the variation.

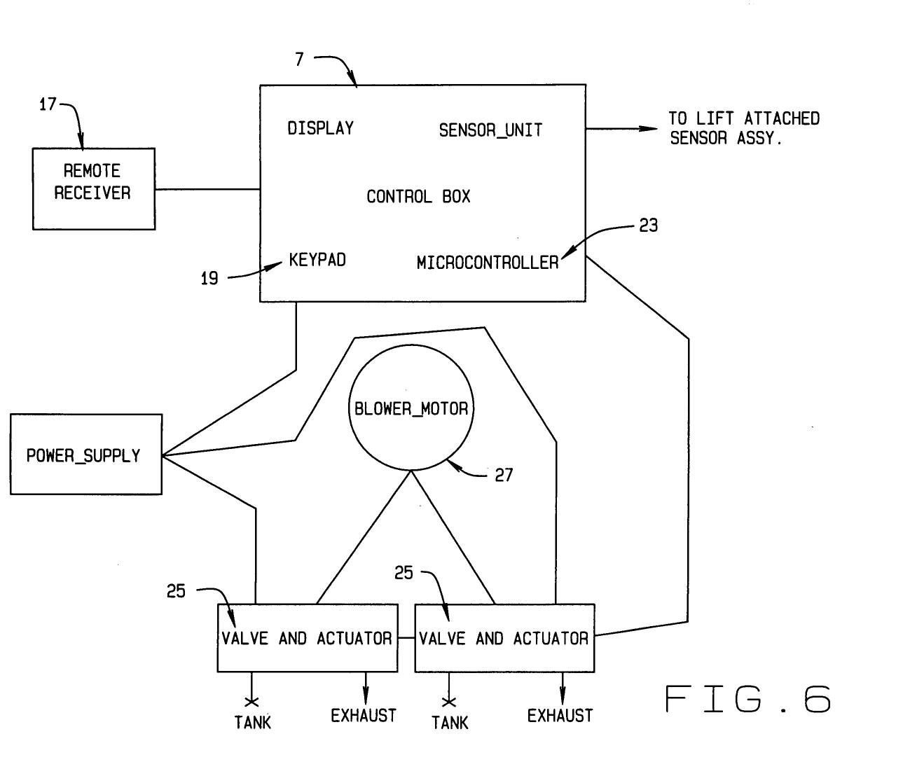

Various configurations of the control electronics may be utilized within the scope of the present invention. For example, electronics that could control cable position could be substituted for those that control the air tanks shown in FIGS. 1-5. Likewise, as shown in FIGS. 6 and 7, the controller system preferably includes a remote receiver 17, allowing adjustment of the lift 9 by a wireless remote control.

In addition, other devices may be used to lower and raise the lift 9 rather than the pneumatic system described. For example, an electric motor may connect mechanically between the lift 9 and the dock 1, allowing the lift 9 to lower or raise.

Those of ordinary skill in the art will recognize that the present invention is not restricted to use with any particular type of boat lift, but rather, may be readily adapted for use with lifts utilizing any lifting mechanism.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

What is claimed is:

1. A position sensing and auto-leveling boat lift comprising;
a boat receiving structure;
a pressure transducer attached to the boat receiving structure;
a tilt sensor attached to the boat receiving structure;
a device for lowering and raising the boat receiving structure between at least a first height and a second height; and
a microcontroller operatively connected to the device for lowering and raising the boat receiving structure for controlling the operation thereof, said microcontroller receiving at one or more inputs from the pressure transducer and the tilt sensor, the microcontroller being adapted to control operation of the boat receiving structure so as to raise or lower one or more portions of the boat receiving structure to maintain the boat lift in a level position at the desired height.

2. The lift of claim 1 wherein the device for lowering and raising the boat receiving structure is an air blower pneumatically connected to the boat receiving structure.

3. The lift of claim 2 wherein an improper installation of the air blower pneumatically connected to the boat receiving structure is recognized by the microcontroller.

4. The lift of claim 1 wherein the pressure transducer is vented to the atmosphere.

5. The lift of claim 1 wherein the device for lowering and raising the boat receiving structure is an electric motor mechanically connected to the boat receiving structure.

6. The lift of claim 1 further including a remote control for operating the lift.

7. The lift of claim 6 further including a warning strobe operatively connected to the boat receiving structure to provide a visual indication of the position of the boat receiving structure.

8. A method of sensing position and auto-leveling a boat lift comprising the steps of:
receiving a plurality of data from a sensor;
comparing the plurality of data with a predetermined value;
manipulating a valve if the plurality of data and the predetermined value are different; and
activating a device to raise or lower a boat receiving structure if the condition if the valve has changed.

9. The method of sensing position and auto-leveling a boat lift of claim 8 wherein the receiving of data is a continuous process.

10. The method of sensing position and auto-leveling a boat lift of claim 8 wherein the comparing of data with the predetermined value is a continuous process.
